(19) United States
(12) Patent Application Publication
(10) Pub. No.: US 2007/0152195 A1
(43) Pub. Date: Jul. 5, 2007

(54) Electrostatic dissipative composite material

(75) Inventors: Pawel Czubarow, Wellesley, MA (US); Mark W. Beltz, Attleboro, MA (US); Oh-Hun Kwon, Westborough, MA (US); Gwo Swei, Vandalia, OH (US)

Correspondence Address: LARSON NEWMAN ABEL POLANSKY & WHITE, LLP, 5914 WEST COURTYARD DRIVE, SUITE 200, AUSTIN, TX, 78730, US

(73) Assignee: SAINT-GOBAIN PERFORMANCE PLASTICS CORPORATION, Aurora, OH (US)

(21) Appl. No.: 11/324,153

(22) Filed: Dec. 30, 2005

(51) Int. Cl. H01B 1/12

(52) U.S. Cl. 252/500

(57) ABSTRACT

A method of forming an electrostatic dissipative composite material includes preparing a mixture comprising a polyamic acid precursor and a non-carbonaceous resistivity modifier. The polyamic acid precursor reacts to form polyamic acid. The method also includes dehydrating the polyamic acid to form polyimide. The polyimide forms a polymer matrix in which the non-carbonaceous resistivity modifier is dispersed.

### FIELD OF THE DISCLOSURE

This disclosure, in general, relates to electrostatic dissipative composite materials, devices formed thereof and methods of forming such composite materials and devices.

### BACKGROUND

In an increasingly technological age, static electricity and electrostatic discharge (ESD) can be costly or dangerous. In particular, electrostatic discharge (ESD) can ignite flammable mixtures and damage electronic components. In addition, static electricity can attract contaminants in clean environments.

Such effects of static electricity and ESD can be costly in electronic device manufacturing. Contaminants attracted by static charge may cause defects in components of electronic devices, leading to poor performance. In addition, ESD can damage components, making a device completely inoperable or reducing device performance or life expectancy. Such losses in performance lead to lower value products, and, in some instances, lost production and higher rejection rate of parts, resulting in higher unit cost

As electronic devices become increasing complex and component sizes decrease, the electronic devices become more susceptible to ESD. In addition, manufacturing of such devices uses intricate processing tools that may be difficult to form from metal. Metal components exhibit transient currents that may result in electrostatic discharge, for example, when first contacting parts. More recently, manufacturers have turned to ceramic materials for use in manufacturing such electronic devices. While ceramic materials are typically insulative, manufacturers use coatings and additives to provide electrostatic dissipative properties to such ceramic materials.

While ceramic materials tend to have high Young's modulus, high wear resistance, and dimensional stability at high temperatures, ceramic materials may be difficult to form and machine into intricate tools and components useful in electronic devices. Typically, formation of ceramic components includes densification performed at high temperatures, often exceeding 1200° C. Once formed, typical electrostatic dissipative ceramics exhibit high density and increased hardness, in some instances exceeding 11 GPa Vicker's hardness, making it difficult to machine detail into ceramic components.

More recently, manufacturers have turned to polymeric electrostatic dissipative materials, and, in particular, polyolefin, polyamideimide, acetal, polytetrafluoroethylene, and polyimide materials. Much like ceramic materials, polymeric materials are generally insulative. As such, polymeric materials are typically coated with an electrostatic dissipative coating or include additives, such as graphite or carbon fiber. While such materials may be easier to form into tooling and electronic components, such polymeric materials typically exhibit poor mechanical properties and poor physical properties relative to ceramic materials. For example, such polymeric materials often exhibit unacceptably low tensile strength and high coefficients of thermal expansion, limiting the applications in which such materials may be useful. Further, such polymeric materials exhibit poor mechanical property retention after exposure to high temperatures. In addition, such polymeric materials often use carbon fibers, carbon black, or graphite. When machined into intricate components having small feature sizes, such materials form shorts and hot spots, leading to electrostatic discharge.

As such, an improved electrostatic dissipative material would be desirable.

### SUMMARY

In a particular embodiment, a method of forming an electrostatic dissipative composite material includes preparing a mixture comprising a polyamic acid precursor and a non-carbonaceous resistivity modifier. The polyamic acid precursor reacts to form polyamic acid. The method also includes dehydrating the polyamic acid to form polyimide. The polyimide forms a polymer matrix in which the non-carbonaceous resistivity modifier is dispersed.

In another exemplary embodiment, a composite material includes a polyimide matrix and a non-carbonaceous resistivity modifier. The composite material has a coefficient of thermal expansion not greater than about 30 ppm/° C. and has a surface resistivity of about 1.0×10⁵ ohm/sq to about 1.0×10¹³ ohm/sq.

In a further exemplary embodiment, a component includes a composite material. The composite material includes a polyimide matrix and a non-carbonaceous resistivity modifier. The composite material has a coefficient of thermal expansion not greater than about 30 ppm/° C. and has a surface resistivity of about 1.0×10⁵ ohm/sq to about 1.0×10¹³ ohm/sq.

In an additional embodiment, a composite material includes a polyimide matrix and a non-carbonaceous resistivity modifier. The composite material has a coefficient of thermal expansion not greater than about 30 ppm/° C. and exhibits a decay time not greater than about 0.5 seconds.

In a further exemplary embodiment, a composite material includes a polyimide matrix and at least about 65 wt % particulate iron oxide. The polyimide matrix is formed of the imidized product of pyromellitic dianhydride and oxydianiline. The composite material has a coefficient of thermal expansion not greater than about 30 ppm/° C. and has a surface resistivity of about 1.010⁵ ohm/sq to about 1.0×101³ ohm/sq.

### BRIEF DESCRIPTION OF THE DRAWINGS

The present disclosure may be better understood, and its numerous features and advantages made apparent to those skilled in the art by referencing the accompanying drawings.

FIGS. 1 and 2 include illustrations of exemplary polymer matrices including dispersed non-carbonaceous resistivity modifier.

FIG. 3 includes an illustration of a polymer matrix including agglomerated particulate.

FIG. 4 includes an illustration of the influence of non-carbonaceous resistivity modifier loading on tensile strength.

### DESCRIPTION OF THE DRAWINGS

In a particular embodiment, a component is formed of a composite material including a polyimide matrix and a non-carbonaceous resistivity modifier dispersed in the polyimide matrix. The composite material exhibits a coefficient of thermal expansion not greater than about 30 ppm/° C. and a surface resistivity of about 1.0×10⁵ ohm/sq to about 1.0×10¹² ohm/sq. In an example, the non-carbonaceous resistivity modifier is a particulate material having an average particle size not greater than about 5 microns, and, in particular, not greater than about 1 micron. In another example, the composite material includes at least about 20 wt % non-carbonaceous resistivity modifier.

In a further exemplary embodiment, a method of forming an electrostatic dissipative composite material includes preparing a mixture including a polyamic acid precursor and a non-carbonaceous resistivity modifier. The polyamic acid precursor reacts to form polyamic acid. The method further includes dehydrating or imidizing the polyamic acid to form a polyimide matrix in which the non-carbonaceous resistivity modifier is dispersed.

The polyamic acid precursor includes a chemical species that may react with itself or another species to form a polyamic acid, which may be dehydrated to form polyimide. In particular, the polyamic acid precursor may be one of a dianhydride or a diamine. Dianhydride and diamine may react to form polyamic acid, which may be imidized to form polyimide.

In an exemplary embodiment, the polyamic acid precursor includes dianhydride, and, in particular, aromatic dianhydrides. An exemplary dianhydride includes pyromellitic dianhydride (PMDA), 2,3,6,7-naphthalenetetracarboxylic acid dianhydride, 3,3′,4,4′-diphenyltetracarboxylic acid dianhydride, 1,2,5,6-naphthalenetetracarboxylic acid dianhydride, 2,2′,3,3′-diphenyltetracarboxylic acid dianhydride, 2,2-bis-(3,4-dicarboxyphenyl)-propane dianhydride, bis-(3,4-dicarboxyphenyl)-sulfone dianhydride, bis-(3,4-dicarboxyphenyl)-ether dianhydride, 2,2-bis-(2,3-dicarboxyphenyl)-propane dianhydride, 1,1-bis-(2,3-dicarboxyphenyl)-ethane dianhydride, 1,1-bis-(3,4-dicarboxyphenyl)-ethane dianhydride, bis-(2,3-dicarboxyphenyl)-methane dianhydride, bis-(3,4-dicarboxyphenyl)-methane dianhydride, 3,4,3′,4′-benzophenonetetracarboxylic acid dianhydride or a mixture thereof. In a particular example, the dianhydride is pyromellitic dianhydride (PMDA). In another example, the dianhydride is benzophenonetetracarboxylic acid dianhydride (BTDA) or diphenyltetracarboxylic acid dianhydride (BPDA).

In another exemplary embodiment, the polyamic acid precursor includes diamine. An exemplary diamine includes oxydianiline, 4,4′-diaminodiphenylpropane, 4,4′-diaminodiphenylmethane, 4,4′-diaminodiphenylamine, benzidine, 4,4′-diaminodiphenyl sulfide, 4,4′-diaminodiphenyl sulfone, 3,3′-diaminodiphenyl sulfone, 4,4′-diaminodiphenyl ether, bis-(4-aminophenyl)diethylsilane, bis-(4-aminophenyl)-phenylphosphine oxide, bis-(4-aminophenyl)-N-methylamine, 1,5-diaminonaphthalene, 3,3′-dimethyl-4,4′-diaminobiphenyl, 3,3′-dimethoxybenzidine, 1,4-bis-(p-aminophenoxy)-benzene, 1,3-bis-(p-aminophenoxy)-benzene, m-phenylenediamine (MPD), p-phenylenediamine (PPD) or a mixture thereof. In a particular example, the diamine is oxydianiline (ODA). In another example, the diamine is m-phenylenediamine (MPD) or p-phenylenediamine (PPD).

The polyamic acid precursors, and, in particular, a dianhydride and a diamine, may react to form polyamic acid, which is imidized to form polyimide. The polyimide forms a polymer matrix of a composite material in which a resistivity modifier may be dispersed. phenylenediamine The resistivity modifier is generally non-carbonaceous. Carbonaceous materials are those materials, excluding polymer, that are formed predominantly of carbon (or organic materials processed to form predominantly carbon), such as graphite, amorphous carbon, diamond, carbon fibers, and fullerenes. Non-carbonaceous materials typically refer to inorganic materials, which are carbon free or, if containing carbon, the carbon is covalently bonded to a cation, such as in the form of a metal carbide material (i.e., carbide ceramic). In an example, the non-carbonaceous resistivity modifier includes a metal oxide, a metal sulfide, a metal nitride, a metal boride, a metal carbide, or a semiconductor having a desirable resistivity. Metal is intended to include metals and semi-metals, including semi-metals of groups 13, 14, 15, and 16 of the periodic table. For example, the non-carbonaceous resistivity modifier may be a carbide or an oxide of a metal. In a particular example, the non-carbonaceous resistivity modifier is an oxide of a metal.

A particular non-carbonaceous resistivity modifier may include NiO, FeO, MnO, Co₂O₃, Cr₂O₃, CuO, Cu₂O, Fe₂O₃, Ga₂O₃, In₂O₃, GeO₂, MnO₂, TiO₂₋ₓ, RuO₂, Rh₂O₃, V₂O₃, Nb₂O₅, Ta₂O₅, WO₃, SnO₂, ZnO, CeO₂, TiO₂₋ₓ, ITO (indium-tin oxide), MgTiO₃, CaTiO₃, BaTiO₃, SrTiO₃, LaCrO₃, LaFeO₃, LaMnO₃, YMnO₃, MgTiO₃F, FeTiO₃, SrSnO₃, CaSnO₃, LiNbO₃, Fe₃O₄, MgFe₂O₄, MnFe₂O₄, CoFe₂O₄, NiFe₂O₄, ZnFe₂O₄, Fe₂O₄, CoFe₂O₄, FeAl₂O₄, MnAl₂O₄, ZnAl₂O₄, ZnLa₂O₄, FeAl₂O₄, MgIn₂O₄, MnIn₂O₄, FeCr₂O₄, NiCr₂O₄, ZnGa₂O₄, LaTaO₄, NdTaO₄, BaFe₁₂O₁₉, 3Y₂O₃.5Fe₂O₃, Bi₂Ru₂O₇, B₄C, SiC, TiC, Ti(CN), Cr₄C, VC, ZrC, TaC, WC, Si₃N₄, TiN, Ti(ON), ZrN, HfN, TiB₂, ZrB₂, CaB₆, LaB₆, NbB₂, MoSi₂, ZnS, Doped-Si, doped SiGe, III-V, II-VI semiconductors, or a mixture thereof. For example, the non-carbonaceous resistivity modifier may include a single oxide of the general formula MO, such as NiO, FeO, MnO, Co₂O₃, Cr₂O₃, CuO, Cu₂O, Fe₂O₃, Ga₂O₃, In₂O₃, GeO₂, MnO₂, TiO₂₋ₓ, RuO₂, Rh₂O₃, V₂O₃, Nb₂O₅, Ta₂O₅, or WO₃. In another example, the non-carbonaceous resistivity modifier may include a doped oxide, such as SnO₂, ZnO, CeO₂, TiO₂₋ₓ, or ITO (indium-tin oxide). In a further example, the non-carbonaceous resistivity modifier may include a perovskite material, such as MgTiO₃, CaTiO₃, BaTiO₃, SrTiO₃, LaCrO₃, LaFeO₃, LaMnO₃, YMnO₃, MgTiO₃F, FeTiO₃, SrSnO₃, CaSnO₃, or LiNbO₃. In an additional example, the non-carbonaceous resistivity modifier may include a spinel material, such as Fe₃O₄, MgFe₂O₄, MnFe₂O₄, CoFe₂O₄, NiFe₂O₄ ZnFe₂O₄, Fe₂O₄, CoFe₂O₄, FeAl₂O₄, MnAl₂O₄, ZnAl₂O₄, ZnLa₂O₄, FeAl₂O₄, MgIn₂O₄, MnIn₂O₄, FeCr₂O₄, NiCr₂O₄, ZnGa₂O₄, LaTaO₄, or NdTaO₄. In another example, the non-carbonaceous resistivity modifier may include a magnetoplumbite material, such as BaFe₁₂O₁₉. In a further example, the non-carbonaceous resistivity modifier may include a garnet material, such as 3Y₂O₃.5Fe₂O₃. In an additional example, the non-carbonaceous resistivity modifier may include other oxides, such as Bi₂Ru₂O₇. In another example, the non-carbonaceous resistivity modifier may include a carbide material having the general formula MC, such as B₄C, SiC, TiC, Ti(CN), Cr₄C, VC, ZrC, TaC, or WC. In a particular example, the non-carbonaceous resistivity modifier includes SiC. In a further example, the non-carbonaceous resistivity modifier may include a nitride material having the general formula MN, such as Si₃N₄, TiN, Ti(ON), ZrN, or HfN. In an additional example, the non-carbonaceous resistivity modifier may include a boride, such as TiB₂, ZrB₂, CaB₆, LaB₆, NbB₂. In another example, the non-carbonaceous resistivity modifier may include a silicide such as MoSi₂, a sulfide such as ZnS, or a semiconducting material such as doped-Si, doped SiGe, III-V, II-VI semiconductors. In a particular example, the non-carbonaceous resistivity modifier includes an oxide of iron, such as Fe₂O₃. In another particular example, the non-carbonaceous resistivity modifier includes an oxide of copper, such as CuO and Cu₂O. In addition, mixtures of these fillers may be used to further tailor the properties of the resulting composite materials, such as resistivity, surface resistance, and mechanical properties. Further electrical properties may be influenced by doping oxides with other oxides or by tailoring the degree of non-stoichiometric oxidation.

In general, the non-carbonaceous resistivity modifier has a desirable resistivity. In an exemplary embodiment, the non-carbonaceous resistivity modifier has a resistivity of about 1.0×10⁻² ohm cm to about 1.0×10⁷ ohm cm, such as about 1.0 ohm cm to about 1.0×10⁵ ohm cm. Particular examples, such as iron oxides and copper oxides have resistivities of about 1×10² to about 1×10⁵ ohm cm.

In general, the non-carbonaceous resistivity modifier includes particulate material. In an example, the particulate material has an average particle size not greater than about 100 microns, such as not greater than about 45 microns or not greater than about 5 microns. For example, the particulate material may have an average particle size not greater than about 1000 nm, such as not greater than about 500 nm or not greater than about 150 nm. In a particular example, the average particle size of the particulate may be at least about 10 nm, such as at least about 50 nm.

In a particular embodiment, the particular material has a low aspect ratio. The aspect ratio is an average ratio of the longest dimension of a particle to the second longest dimension perpendicular to the longest dimension. For example, the particulate material may have an average aspect ratio not greater than about 2.0, such as not greater than about 1.5, or about 1.0. In a particular example, the particulate material is generally spherical.

In an exemplary embodiment, the composite material includes at least about 20 wt % non-carbonaceous resistivity modifier. For example, the composite material may include at least about 40 wt % non-carbonaceous resistivity modifier, such as at least about 55 wt %, at least about 65 wt %, at least about 70 wt %, or at least about 75 wt % non-carbonaceous resistivity modifier. However, too much resistivity modifier may adversely influence physical, electrical, and mechanical properties. As such, the composite material may include not greater than about 95 wt % non-carbonaceous resistivity modifier, such as not greater than about 90 wt % or not greater than about 85 wt % non-carbonaceous resistivity modifier.

In another exemplary embodiment, the composite material may include small amounts of a second filler, such as a metal oxide. In particular, the polyimide matrix may include less than about 5.0 wt % of an oxide of boron, phosphorous, antimony or tungsten. Further, the composite material may include a coupling agent, a wetting agent, or a surfactant. In a particular embodiment, the composite material is free of coupling agents, wetting agents, and surfactants.

The composite material may exhibit desirable surface resistivity and surface resistance. In an exemplary embodiment, the composite material exhibits a surface resistivity of about 1.0×10⁵ ohm/sq to about 1.0×10¹³ ohm/sq. For example, the composite material may exhibit a surface resistivity of about 1.0×10⁵ ohm/sq to about 1.0×10¹² ohm/sq, such as about 1.0×10⁵ ohm/sq to about 1.0×10⁹ ohm/sq or about 1.0×10⁵ ohm/sq to about 1.0×10⁷ ohm/sq. In an exemplary embodiment, the composite material exhibits a surface resistance not greater than about 1.0×10¹² ohms, such as not greater than about 1.0×10⁹ ohms, not greater than about 1.0×10⁸ ohms, or not greater than about 5.0×10⁷ ohms. For example, the composite material may exhibit a surface resistance not greater than about 5.0×10⁶ ohms, such as not greater than about 1.0×10⁶ ohms. In a particular embodiment, the surface resistance is not greater than about 9.0×10⁵ ohms.

In addition, the composite material may exhibit a desirable volume resistivity. In an exemplary embodiment, the composite material exhibits a volume resistivity not greater than about 1.0×10⁸ ohm cm, such as not greater than about 5.0×10⁶ ohm cm. For example, the volume resistivity may be not greater than about 1.0×10⁵ ohm cm. Typically, the volume resistivity is about 1.0×10⁴ to about 1.0×10¹¹ ohm cm, such as about 1.0×10⁴ to about 1.0×10⁸ ohm cm or about 1.0×10⁴ to about 5.0×10⁶ ohm cm.

Further, the composite material may exhibit a decay time not greater than 0.5 seconds. The decay time is a measure of the time to dissipate static charge from 10V to 1V relative to ground. A disc shaped sample is placed on a charged plate, voltage is applied to the plate, and an oscilloscope measures the dissipation time. For example, the decay time may be measured using an Ion Systems Charged Plate Monitor Model 210 CPM, a LeCroy 9310Am Dual 400 MHz Oscilloscope, and a Keithley 6517A electrometer. In an exemplary embodiment, the composite material may exhibit a decay time not greater than about 0.1 seconds, such as not greater than about 0.05 seconds or not greater than about 0.01 seconds.

In particular embodiments, the composite material is used in components that undergo large temperature changes and may operate at high temperatures over extended time periods. As such, the composite material desirably has a low coefficient of thermal expansion and high temperature stability. In an example, the coefficient of thermal expansion (CTE) of the composite material is not greater than about 30 ppm/° C. when measured from 25° C. to 250° C. For example, the CTE of the composite material may be not greater than about 25 ppm/° C., such as not greater than about 20 ppm/° C. In addition, the composite material may exhibit a glass transition temperature (T_{g}) at least about 300° C., such as at least about 330° C. or at least about 340° C. The glass transition temperature may be measured using dynamic mechanical thermal analysis (DMA). In an example, DMA is performed using a DMA Q800 by TA Instruments under the conditions: amplitude 15 microns, frequency 1 Hz, air atmosphere, and a temperature program increasing from room temperature to 600° C. at a rate of 5° C./min. Further, the composite material may be rated for intermittent operation at temperatures at least about 460° C., such as at least about 482° C.

The composite material may also exhibit desirable mechanical properties. For example, the composite material may have a desirable tensile strength relative to the polyimide absent the non-carbonaceous resistivity modifier. In an exemplary embodiment, the composite material has a tensile strength performance, defined as the ratio of the tensile strength of the composite material to the tensile strength of the polyimide absent the non-carbonaceous resistivity modifier, of at least about 0.6. For example, the composite material may have a relative strength performance of at least about 0.8, or, in particular, at least about 0.9, such as at least about 0.95, at least about 1.0, at least about 1.25, or at least about 1.5. In an embodiment, the composite material may exhibit a tensile strength of at least about 44.8 MPa (6500 psi). In an example, the tensile strength of the composite material is at least about 58.6 MPa (8500 psi), such as at least about 63.3 MPa (9200 psi), at least about 66.1 MPa (9600 psi), at least about 72.3 MPa (10500 psi). Particular examples exhibit tensile strength of at least about 86.18 MPa (12,500 psi). The tensile strength may, for example, be determined using a standard technique, such as ASTM D6456 using specimens conforming to D1708 and E8.

In another example, the composite material may exhibit a Young's modulus of at least about 2.5 GPa at 200° C. For example, at 200° C., the Young's modulus of the composite material may be at least about 5.0 GPa, such as at least about 6.5 GPa, at least about 6.8 GPa, or at least about 7.0 GPa. At room temperature (about 25° C.), the Young's modulus of the composite material may be at least about 20 GPA, such as at least about 30 GPa or at least about 40 GPa. In addition, the composite material may exhibit a Vicker's hardness of at least about 0.25 GPa. In an example, the Vicker's hardness of the composite material is at least about 0.30 GPa, such as at least about 0.35 GPa.

In an exemplary method, the composite material is formed by preparing a mixture including unreacted polyamic acid precursors and a non-carbonaceous resistivity modifier. In a particular example, the mixture includes the non-carbonaceous resistivity modifier and at least one of a dianhydride and a diamine. The mixture may further include a solvent or a blend of solvents.

A solvent may be selected whose functional groups do not react with either of the reactants to any appreciable extent. In addition to being a solvent for the polyamic acid, the solvent is typically a solvent for at least one of the reactants (e.g., the diamine or the dianhydride). In a particular embodiment, the solvent is a solvent for both of the diamine and the dianhydride.

The solvent may be a polar solvent, a non-polar solvent or a mixture thereof. In one exemplary embodiment, the solvent is an aprotic dipolar organic solvent. An exemplary aprotic dipolar solvent includes N,N-dialkylcarboxylamide, N,N-dimethylformamide, N,N-dimethylacetamide, N,N-diethylformamaide, N,N-diethylacetamide, N,N-dimethylmethoxyacetamide, N-methyl caprolactam, dimethylsulfoxide, N-methyl-2-pyrrolidone, tetramethyl urea, pyridine, dimethylsulfone, hexamethylphosphoramide, tetramethylene sulfone, formamide, N-methylformamide, butylrolactone, or a mixture thereof. An exemplary non-polar solvent includes benzene, benzonitrile, dioxane, xylene, toluene, cyclohexane or a mixture thereof. Other exemplary solvents are of the halohydrocarbon class and include, for example, chlorobenzene.

In one exemplary embodiment, the solvent solution includes a mixture of at least two solvents. The solvent ratio may result from mixing prior to adding reactant, may result from combining two reactant mixtures, or may result from addition of solvents or water entraining components during various parts of the process. In one exemplary embodiment, the resulting solvent mixture, such as the solvent mixture during polyamic acid imidization, includes an aprotic dipolar solvent and a non-polar solvent. The aprotic dipolar solvent and non-polar solvent may form a mixture having a ratio of 1:9 to 9:1 aprotic dipolar solvent to non-polar solvent, such as 1:3 to 6:1. For example, the ratio may be 1:1 to 6: 1, such as 3.5:1 to 4:1 aprotic dipolar solvent to non-polar solvent.

Depending on the polyimide formation process, the solvent may be added prior to polyamic acid polymerization, during polyamic acid polymerization, after polyamic acid polymerization, during polyimide formation, after polyimide formation, or a combination thereof. For solution formed polyimide, reactants may be provided in solvent solutions or added to solvent solutions. Additional solvents may be added prior to dehydration or imidization, such as prior to azeotropic distillation. For precipitation formed polyimide, reactants may be provided in solvents or added to solvents. Polyimide may be precipitated from the solvent mixture through addition of dehydrating agents.

According to an embodiment, the non-carbonaceous resistivity modifier may be added along with at least one polyamic acid precursor to solvent prior to polymerization of the polyamic acid precursors. The addition may be performed under high shear conditions. In a particular embodiment, the non-carbonaceous resistivity modifier may be milled, such as through ball milling, prior to addition to the mixture. In another exemplary embodiment, the non-carbonaceous resistivity modifier may be heat treated in a dry atmosphere prior to adding to the mixture. For example, the non-carbonaceous resistivity modifier may be heat treated in a nitrogen atmosphere for about 2 hours at about 700° C. Generally, the mixture including the non-carbonaceous resistivity modifier and the polyamic acid precursor in solvent has a Hegman grind gauge reading not greater than 5 microns, such as not greater than 1 micron.

In an exemplary method, a second polyamic acid precursor may be added to the mixture either in the form of a second mixture or as a dry component. For example, the polyamic acid mixture may be prepared by reacting a diamine component with a dianhydride component. In an exemplary embodiment, the dianhydride component is added to a solvent mixture including the diamine component. In another exemplary embodiment, the dianhydride component is mixed with the diamine without solvent to form a dry mixture. Solvent is added to the dry mixture in measured quantities to control the reaction and form the polyamide mixture. In such an example, the non-carbonaceous resistivity modifier may be mixed with the dry mixture prior to addition of the solvent. In a further exemplary embodiment, a mixture including diamine and a solvent is mixed with a second mixture including the dianhydride component and a solvent to form the polyamide mixture. The non-carbonaceous resistivity modifier may be included in one or both of the mixtures.

In general, the polyamic acid reaction is exothermic. As such, the mixture may be cooled to control the reaction. In a particular embodiment, the temperature of the mixture may be maintained or controlled at about −10° C. to about 100° C., such as about 25° C. to about 70° C.

The polyamic acid may be dehydrated or imidized to form polyimide. The polyimide may be formed in solution from the polyamic acid mixture. For example, a Lewis base, such as a tertiary amine, may be added to the polyamic acid mixture and the polyamic acid mixture heated to form a polyimide mixture. Portions of the solvent may act to form azeotropes with water formed as a byproduct of the imidization. In an exemplary embodiment, the water byproduct may be removed by azeotropic distillation. See, for example, U.S. Pat. No. 4,413,117 or U.S. Pat. No. 3,422,061.

In another exemplary embodiment, polyimide may be precipitated from the polyamic acid mixture, for example, through addition of a dehydrating agent. Exemplary dehydrating agents include fatty acid anhydrides formed from acetic acid, propionic acid, butyric acid, or valeric acid, aromatic anhydrides formed from benzoic acid or napthoic acid, anhydrides of carbonic acid or formic acid, aliphatic ketenes, or mixtures thereof. See, for example, U.S. Pat. No. 3,422,061.

In general, the polyimide product forms solids that are typically filtered, washed, and dried. For example, polyimide precipitate may be filtered and washed in a mixture including methanol, such as a mixture of methanol and water. The washed polyimide may be dried at a temperature between about 150° C. and about 300° C. for a period between 5 and 30 hours and, in general, at or below atmospheric pressure, such as partial vacuum (500-700 torr) or full vacuum (50-100 torr). As a result, a composite material is formed including a polyimide matrix having non-carbonaceous resistivity modifier dispersed therein. The non-carbonaceous resistivity modifier is generally evenly dispersed, providing substantially regionally invariant resistive properties.

To form an article, the composite material may be hot pressed or press sintered. In another example, the composite material may be pressed and subsequently sintered to form the component. For example, the polyimide may be molded using high pressure sintering at temperatures of about 250° C. to about 450° C., such as about 350° C. and pressures at least about 351 kg/cm² (5 ksi), such as about 351 kg/cm² (5 ksi) to about 1406 kg/cm² (20 ksi) or, in other embodiments, as high as about 6250 kg/cm² (88.87 ksi).

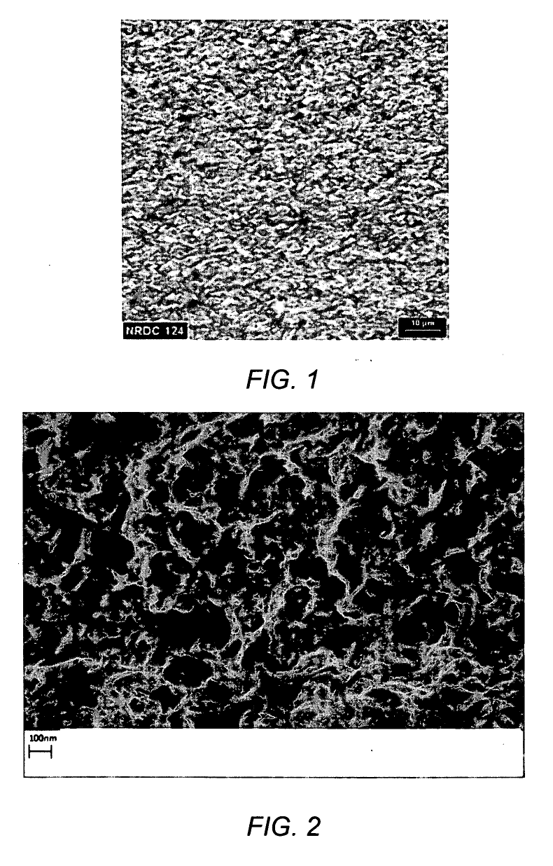

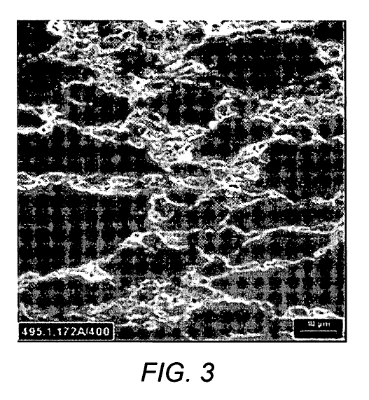

As illustrated in FIG. 1, the SEM image of a polished cross section of the resulting article exhibits a dispersed non-carbonaceous resistivity modifier and is substantially free of non-carbonaceous resistivity modifier agglomerates. Such substantially agglomerate free dispersion provides substantially invariant resistivity properties, reducing ESD risk associated with alternating regions of high and low resistivity. FIG. 2 includes an SEM image at higher magnification of a highly loaded composite. The dispersed non-carbonaceous resistivity modifier is separated by polymer and does not form agglomerates. In contrast FIG. 3 illustrates the SEM image of a polished cross section of a sintered composite material formed by blending particulate material with the polymer after imidization. As illustrated in FIG. 3, post-imidization blending of particulate material results in agglomerate formation and can lead to resistivity variation between regions.

### EXAMPLES

Samples are prepared from mixtures including resistivity modifier and pyromellitic dianhydride (PMDA) and oxydianiline (ODA). The polyamic acid product of PMDA and ODA is imidized through azeotropic distillation. The composite material, including polyimide and dispersed resistivity modifier, is formed into test samples through hot pressing.

Table 1 illustrates the coefficient of thermal expansion (CTE) and surface resistance of samples formed of a variety of resistivity modifiers. Those samples denoted with an “M” superscript include resistivity modifier that is ball milled prior to addition to the mixture and those samples denoted with a “T” include heat-treated non-carbonaceous resistivity modifier. In general, those samples including at least 20 wt % non-carbonaceous resistivity modifier exhibit improved CTE. For example, Samples 1, 4, 9, 10, and 11 exhibit CTE not greater than 30 ppm/° C., and, in particular, samples 9, 10, 11 exhibit CTE not greater than 20 ppm/° C. In addition, particular samples exhibit surface resistance not greater than 5.0 E7 ohms. For example, samples 9, 10, and 11 exhibit surface resistance not greater than 1.0 E6 ohms.

TABLE 1
Effect of Resistivity Modifier on CTE and Surface Resistance

| | | CTE | Molded Surface |
|---|---|---|---|
| | Resistivity | (ppm/° C.) | Resistance |
| Sample | Modifier | RT-200° C. | (Ohm) |
| 1 | 60 wt % Si | 26 | 2.2E7 |
| 2 | 51 wt % MoS₂ | 46 | 4.7E10 |
| 3 | 44 wt % SiC | 40 | 4.5E11 |
| 4^{M} | 71 wt % SiC | 20 | 6E11 |
| 5^{T} | 50 wt % TiO₂ | 41 | 7.8E10 |
| 6^{T} | 57 wt % Fe₂O₃ | 35 | 2.5E8 |
| 7^{M} | 57 wt % Fe₂O₃ | 44 | 4.9E7 |
| 8 | 57 wt % Fe₂O₃ | 42 | 1.2E8 |
| 9 | 79 wt % Fe₂O₃ | 16 | 8.5E5 |
| 10 | 85 wt % Fe₂O₃ | 12 | 4.1E5 |
| 11^{M} | 79 wt % Fe₂O₃ | 19 | 3.5E5 |

^{M}Filler ball milled
^{T}Filler heat treated in N₂ at 700° C. prior to polymerization

As illustrated in Table 2, Samples 9, 10, and 11 exhibit desirable decay times less that 1 second, such as not greater than 0.5 seconds. In particular, Samples, 10 and 11 exhibit decay times on the order of 10⁻³seconds. Decay times are determined as the time to decay a 10V charge to 1V. While such decay times are not as low as the decay time exhibited by Cerastat®, a commercial electrostatic dissipative ceramic, such decay times represent improvement over electrostatic dissipative polymeric products, Pomaluxe SD-A and Semitron® S240.

TABLE 2
Comparison of Decay Time of Samples with
those of Commercial Products

| Material | Decay Times (s) |
|---|---|
| Sample 8 | 128 |
| Sample 9 | 332E−3 |
| Sample 10 | 3E−3 |
| Sample 11 | 1.8E−3 |
| Cerastat ® | 164E−6 |
| Pomalux ® SD-A | 83 |
| Semitron ® S420 | 1 |

In addition to improved decay time, particular samples exhibit improved hardness relative to ESD commercial polymer products Semitron(® S420 and Pomalux® SD-A. Specifically, samples 9, 10, and 11 exhibit hardness at least about 0.30 GPa and, typically, at least about 0.35 GPa.

TABLE 3
Hardness of Samples Relative to Commercial Products

| | CTE | |
|---|---|---|
| Material | (ppm/° C.) | Hardness (GPa) |
| Sample 6 | 35 | 0.216 |
| Sample 8 | 42 | 0.269 |
| Sample 9 | 16 | 0.386 |
| Sample 10 | 12 | 0.395 |
| Sample 11 | 19 | 0.495 |
| Meldin 7001 | 50 | 0.148 |
| Semitron ® | 50 | 0.300 |
| S420 ® | | |
| Pomalux ® SD-A | 200 | 0.08 |

### Example 2

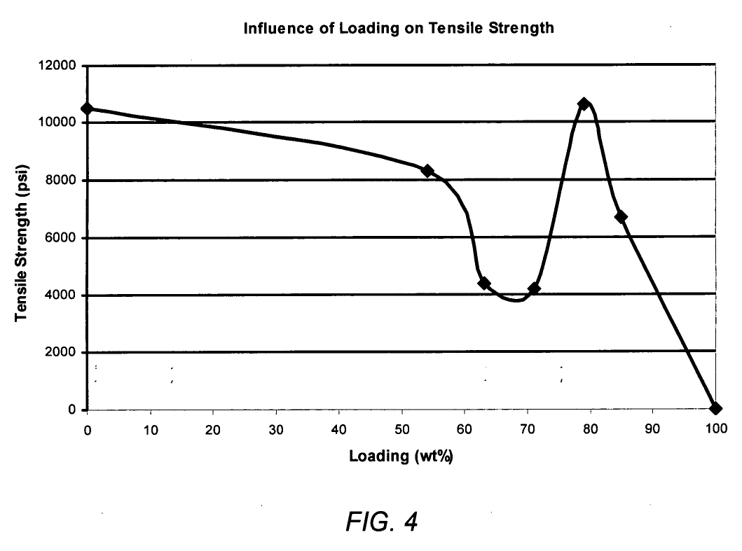

In particular examples, non-carbonaceous resistivity modifier loading influences properties, such as CTE and tensile strength. FIG. 4 illustrates the affect of loading on tensile strength. In particular, FIG. 4 represents the tensile strength of samples including a weight percent of particulate iron oxide having a primary particle size of 100 nm. The highly loaded polyimide including 79 wt % iron oxide exhibits tensile strength as high as virgin polyimide, greater than 73.08 MPa (10,600 psi) on average and samples as high as 86.18 MPa (12,500 psi). In addition, the Young's modulus at 200° C. of samples including 55 wt % and 79 wt % iron oxide are 3 GPa and 7 GPa, respectively. At room temperature (about 25° C.), a sample including 79 wt % iron oxide has a Young's modulus of 42.05 GPa (6100 ksi). Further such composites exhibit qualities similar to graphite when machining. For example, a wall thickness of less than 15 mils may be machined into the composite.

### Example 3

In a further example, a composite material including 79 wt % copper I oxide is formed in accordance with EXAMPLE 1. At room temperature, the sample exhibits a tensile strength of 63.5 MPa (9208 psi) and a Young's modulus of 21.4 GPa (3111 ksi). The sample has a specific gravity of 3.623.

Particular embodiments of the above-disclosed composite materials advantageously exhibit low voltage decay times. While not intending to be limited to a particular theory, it is believed that the homogeneity of the dispersion of the non-carbonaceous resistivity modifier contributes to improved voltage decay characteristics. Such dispersion may be produced as a result of including the non-carbonaceous resistivity modifier in the pre-reacted mixture with at least one of the polymer precursors prior to polymerization of the polymer precursors.

In another particular embodiment, the above-disclosed composite material advantageously exhibits low coefficient of thermal expansion. It is believed, without intending to be limited to a particular theory, that homogeneous dispersion of a particular non-carbonaceous resistivity modifier, such as metal oxides and, in particular, iron oxide, provides a polyimide composite material having a low coefficient of thermal expansion and desirable resistivity properties. In addition, high loading of low average particle size non-carbonaceous resistivity modifiers may advantageously improve mechanical properties, such as tensile strength, of particular embodiments of the above-disclosed composite material.

While the invention has been illustrated and described in the context of specific embodiments, it is not intended to be limited to the details shown, since various modifications and substitutions can be made without departing in any way from the scope of the present invention. For example, additional or equivalent substitutes can be provided and additional or equivalent production steps can be employed. As such, further modifications and equivalents of the invention herein disclosed may occur to persons skilled in the art using no more than routine experimentation, and all such modifications and equivalents are believed to be within the scope of the invention as defined by the following claims.

1. A method of forming an electrostatic dissipative composite material, the method comprising:
preparing a mixture comprising a polyamic acid precursor and a non-carbonaceous resistivity modifier, the polyamic acid precursor reacting to form polyamic acid; and
dehydrating the polyamic acid to form polyimide, the polyimide forming a polymer matrix in which the non-carbonaceous resistivity modifier is dispersed.

2. The method of claim 1, further comprising adding a second polyamic acid precursor, resulting in the polyamic acid precursor and the second polyamic acid precursor reacting to form polyamic acid.

3. The method of claim 1, further comprising mixing the mixture under high shear.

4. The method of claim 1, wherein the mixture has a Hegman grind gauge value not greater than 1 micron.

5. The method of claim 1, wherein the non-carbonaceous resistivity modifier includes a metal oxide, a metal carbide, a metal nitride, a metal boride, or a metal sulfide.

6. The method of claim 5, wherein the non-carbonaceous resistivity modifier includes a metal oxide.

7. The method of claim 6, wherein the metal oxide comprises an oxide of iron.

8. The method of claim 6, wherein the metal oxide comprises an oxide of copper.

9. The method of claim 1, further comprising milling the non-carbonaceous resistivity modifier.

10. The method of claim 9, wherein milling the non-carbonaceous resistivity modifier includes milling the non-carbonaceous resistivity modifier prior to preparing the mixture.

11.-20. (canceled)

21. A composite material comprising a polyimide matrix and a non-carbonaceous resistivity modifier, the composite material having a coefficient of thermal expansion not greater than about 30 ppm/° C. and having a surface resistivity of about 1.0×10⁵ ohm/sq to about 1.0×10¹³ ohm/sq.

22. The composite material of claim 21, wherein the non-carbonaceous resistivity modifier is selected from the group consisting of NiO, FeO, MnO, Co₂O₃, Cr₂O₃, CuO, Cu₂O, Fe₂O₃, Ga₂O₃, In₂O₃, GeO₂, MnO₂, TiO₂₋ₓ, RuO₂, Rh₂O₃, V₂O₃, Nb₂O₅, Ta₂O₅, WO₃, SnO₂, ZnO, CeO₂, TiO₂₋ₓ, ITO (indium-tin oxide), MgTiO₃, CaTiO₃, BaTiO₃, SrTiO₃, LaCrO₃, LaFeO₃, LaMnO₃, YMnO₃, MgTiO₃F, FeTiO₃, SrSnO₃, CaSnO₃, LiNbO₃, Fe₃O₄, MgFe₂O₄, MnFe₂O₄, CoFe₂O₄, NiFe₂O₄ ZnFe₂O₄, Fe₂O₄, CoFe₂O₄, FeAl₂O₄, MnAl₂O₄, ZnAl₂O₄, ZnLa₂O₄, FeAl₂O₄, MgIn₂O₄, MnIn₂O₄, FeCr₂O₄, NiCr₂O₄, ZnGa₂O₄, LaTaO₄, NdTaO₄, BaFe₁₂O₁₉, 3Y₂O₃.5Fe₂O₃, Bi₂Ru₂O₇, B₄C, SiC, TiC, Ti(CN), Cr₄C, VC, ZrC, TaC, WC, Si₃N₄, TiN, Ti(ON), ZrN, HfN, TiB₂, ZrB₂, CaB₆, LaB₆, NbB₂, MoSi₂, ZnS, Doped-Si, doped SiGe, III-V, II-VI semiconductors, and a mixture thereof.

23. The composite material of claim 22, wherein the non-carbonaceous resistivity modifier is selected from the group consisting of NiO, FeO, MnO, Co₂O₃, Cr₂O₃, CuO, Cu₂O, Fe₂O₃, Ga₂O₃, In₂O₃, GeO₂, MnO₂, TiO₂₋ₓ, RuO₂, Rh₂O₃, V₂O₃, Nb₂O₅, Ta₂O₅, and WO₃.

24.-32. (canceled)

33. The composite material of claim 22, wherein the non-carbonaceous resistivity modifier includes a carbide material.

34.-35. (canceled)

36. The composite material of claim 22, wherein the non-carbonaceous resistivity modifier includes a nitride material.

37. (canceled)

38. The composite material of claim 22, wherein the non-carbonaceous resistivity modifier includes a boride.

39.-43. (canceled)

44. The composite material of claim 22, wherein the non-carbonaceous resistivity modifier includes an oxide of iron.

45. The composite material of claim 22, wherein the non-carbonaceous resistivity modifier includes an oxide of copper.

46. The composite material of claim 21, wherein the composite material comprises at least about 20 wt % of the non-carbonaceous resistivity modifier.

47. The composite material of claim 46, wherein the composite material comprises at least about 55 wt % of the non-carbonaceous resistivity modifier.

48.-51. (canceled)

52. The composite material of claim 21, wherein the non-carbonaceous resistivity modifier has a volume resistivity of about 1.0×10⁻² ohm cm to about 1.0×10⁷ ohm cm.

53.-54. (canceled)

55. The composite material of claim 21, wherein the composite material exhibits a decay time not greater than about 0.5 seconds.

56.-57. (canceled)

58. The composite material of claim 21, wherein the surface resistivity is about 1.0×10⁵ ohm/sq to about 1.0×10⁹ ohm/sq.

59.-68. (canceled)

69. The composite material of claim 21, wherein the coefficient of thermal expansion is not greater than about 25 ppm/° C.

70.-72. (canceled)

73. The composite material of claim 21, wherein the polyimide comprises the imidized product of pyromellitic dianhydride and oxydianiline.

74.-97. (canceled)

98. A composite material comprising a polyimide matrix and at least about 65 wt % particulate iron oxide, the polyimide matrix formed of the imidized product of pyromellitic dianhydride and oxydianiline, the composite material having a coefficient of thermal expansion not greater than about 30 ppm/° C. and having a surface resistivity of about 1.0×10⁵ ohm/sq to about 1.0×10¹³ ohm/sq.

99. (Canceled)
